(19) United States
(12) Patent Application Publication
(10) Pub. No.: US 2011/0089706 A1
(43) Pub. Date: Apr. 21, 2011

(54) ABSORBER ELEMENT FOR A MOTOR VEHICLE LOCK

(75) Inventors: Thorsten Bendel, Oberhausen (DE); Klaus Götzen, Mulheim (DE); Dieter Meyer, Wolfsburg (DE); Jens Richter, Wolfsburg (DE); Kay-Olaf Loock, Wolfsburg (DE); Kai Schrenke, Walbeck (DE); Wolfgang Hogräfer, Braunschweig (DE)

(73) Assignee: KIEKERT AG, Heiligenhaus (DE)

(21) Appl. No.: 12/997,594

(22) PCT Filed: Jul. 1, 2009
(86) PCT No.: PCT/DE2009/000930

§ 371 Date: Dec. 11, 2010

(30) Foreign Application Priority Data
Jul. 3, 2008 (DE) 10 2008 031 206.1

(51) Int. Cl. E05B 15/02

(52) U.S. Cl. 292/341.12

(57) ABSTRACT

Device (1) for a motor vehicle lock (2) comprising an inlet (3) for a latch pin (4), wherein the inlet (3) has an entrance region (5) and an end region (6) with at least one damper element (7) which can absorb the contact force from the latch pin (4), wherein the damper element (7) has at least one opening (8), in which at least the rigid insert (9) is disposed against the damper element (7).

The present invention relates to a device for a motor vehicle lock comprising an inlet for a latch pin, wherein the inlet has an entrance region and an end region with at least one damper element. The damper element is suitable for absorbing a contact force originating from the latch pin. In particular, the invention relates to a motor vehicle door lock with a locking mechanism comprising a catch, a pawl, and a latch pin (also called a locking bolt, a striker, etc.) that moves inwardly into a so-called inlet or that cooperates with the catch, and wherein said inlet or said seat comprise at least one such damper element.

Such motor vehicle door locks are generally known. The damper element has the task of receiving and holding the latch pin as it moves inward into an inlet, while minimizing noise, and finally the latch pin is held in a latched position. In general, the latch pin and the inlet move with respect to one another. The latch pin is usually secured to the motor vehicle body and the motor vehicle door (with the corresponding motor vehicle lock) is moved toward the latch pin. The inlet may possibly also have the function of leading the latch pin upon entry or exit into the inlet and to lift it into the correct position.

Such damper elements have been found particularly appropriate for reducing noise during the closing of motor vehicle locks. However, there remains a need to further improvements. In addition, it should be ensured that the latch pin in such motor vehicle locks is fixed securely against the inlet or the catch.

On this basis, the present invention solves the prior art problems, at least partially. In particular, a device is to be developed that allows for a motor vehicle lock to close and open smoothly and quietly into and out of the locked position while experiencing dynamic and static loads.

These tasks are achieved with a locking device having the features as put forth in claim 1. Advantageous embodiments of the device are given in the dependent claims. In addition, the description mentions a number of other embodiments of the invention that are also very beneficial.

The inventive device for a motor vehicle lock comprises an inlet for a latch pin, wherein the inlet has an entrance region and an end region with at least one damper element, the damper element can absorb a contact force coming from the latch pin, the damper element has at least one opening, and a rigid insert is disposed in the opening against the damper element.

The invention makes use of the idea that the damper element is itself formed locally using portions that are rigid with respect to other portions of the damper element. Such rigid portions can be used, in particular, for fixing the position or for guiding of the latch pin.

The damper element is generally made of a thermoplastic plastic, in particular, polyurethane (PUR) or rubber. It has, for example, a Shore A hardness of between 60 and 90, preferably about 70.

In contrast, the proposed rigid insert is characterized by a greater hardness and/or a smaller deformation response compared to the damper element (with respect to incoming contact forces).

The opening in the damper element may be formed all the way through the damper element. However, it is preferred that the opening is not formed all the way through. The opening preferably extends substantially parallel to the adjacent latch pin. In principle, the cross-sectional shapes of the opening are adjusted based on the needs. However, in most cases, a round or cylindrical opening is useful. The number of openings in the damper element can also be adjusted. However, between 1 and 3 openings are preferred. Not all of the openings must be implemented with a rigid insert.

The rigid insert is preferably maintained in the opening without additional connecting means. Thus, preferred are form-locking and/or frictional connections, for example a press fit. In this way, it is possible to generate a bulge extending as desired on the top side of the damper element towards the latch pin. Thus, application-specific adjustments can be made with a (standardized) bore and different sizes of the rigid insert.

According to a further embodiment of the device, the opening is a blind bore and the rigid insert is a plastic pin. In this case, it is preferred that the bore has the same or even a slightly smaller diameter than the rigid insert to be positioned in the bore. In this case, this rigid insert is cylindrical in shape and is so inserted into the blind bore that a press fit is formed with the damper element. Here, the plastic pin is advantageously surrounded laterally by the damper element. The plastic used has, in particular, a higher Shore A hardness than the damper element. The Shore A hardness of the plastic pin is preferably at least 20% higher than the Shore A hardness of the damper element, in particular, higher by at least 50% or even 100% than the Shore A hardness of the damper element. The preferred material here is POM (polyoxymethylene) or a similar material.

In addition, it is considered advantageous that the damper element and the rigid insert form a bearing lining for the latch pin. Bearing means, in particular, a connection between the latch pin and the catch encompassing the latch pin in the closed position of the catch. Exactly in this situation, therefore, the section of the damper element with the rigid insert serves as a supporting surface for the bearing. In particular, this facilitates a kind of fixation of the latch pin in the locked position of the bolt so that the relative motion of the catch and the locking pin in this position is reduced or avoided during vehicle operation. In addition, the device can play here a guiding role, for example, to achieve tolerance compensation in the positioning of the latch pin and the catch.

It is also considered advantageous that the rigid insert is laterally positioned with respect to a latched position of the latch pin in the inlet. In other words, in particular, the rigid insert is oriented laterally with respect to the latch pin, in the locked position of the latch pin. The rigid insert and the latch pin lie, e.g., in the same plane, which is perpendicular to the plane defined by the inward movement of the latch pin into the inlet.

The invention is further illustrated below with reference to the figures, which show various preferred embodiments.

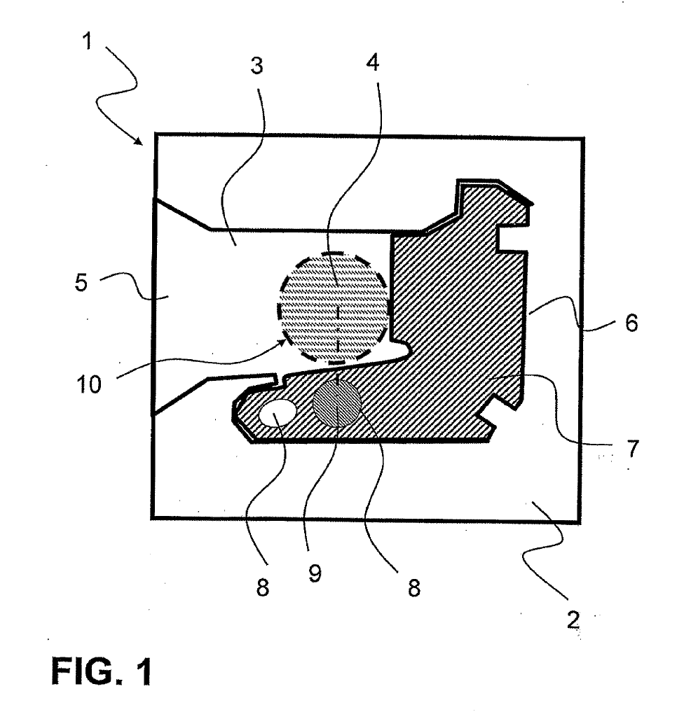

FIG. 1 illustrates a first embodiment of the device 1 for a motor vehicle lock 2. The motor vehicle lock 2 forms an inlet 3 for the indicated latch pin 4. With reference to FIG. 1, the inlet 3 passes from the left side (entrance region 5 for the latch pin 4) into the inner area of the motor vehicle lock 2 up to the end region 6. In the end region 6, disposed is an L-shaped damper element 7, which can take up a contact force originating from the latch pin 4. The damper element 7 has, at the bottom and in the side area of the inlet 3 between the entrance region 5 and the end region 6, several inboard openings 8. A rigid insert 9 is inserted into the opening 8. In the illustrated embodiment, the opening 8 with the rigid insert 9 is formed in the style of a bore, which is positioned in vertical alignment with respect to the latch pin 4 being installed at the shorter L-leg of the damper element 7 in the closed position of the locking mechanism (not shown here). The rigid insert 9 is formed as a kind of a plastic pin. The plastic pin has a diameter that corresponds to the diameter of the opening, wherein it is preferred that the connection between the opening and plastic pin is a press fit.

The diameter of the rigid insert is preferably between 3 mm and 5 mm, in particular, from 3.8 mm to 4.2 mm.

In addition, the damper element has one additional opening 8 (here illustrated without an inner insert). The position of the additional opening may also be provided in the region of the damper element 7, which is nearer to the end region 6 of the inlet.

In the illustrated embodiment, the rigid insert 9 is disposed laterally and toward a latched position 10, in which the latch pin 4 is shown. In this way, a bearing lining is formed, which, by means of a rigid insert 7, provides positional stability with respect to the position of the latch pin 4.

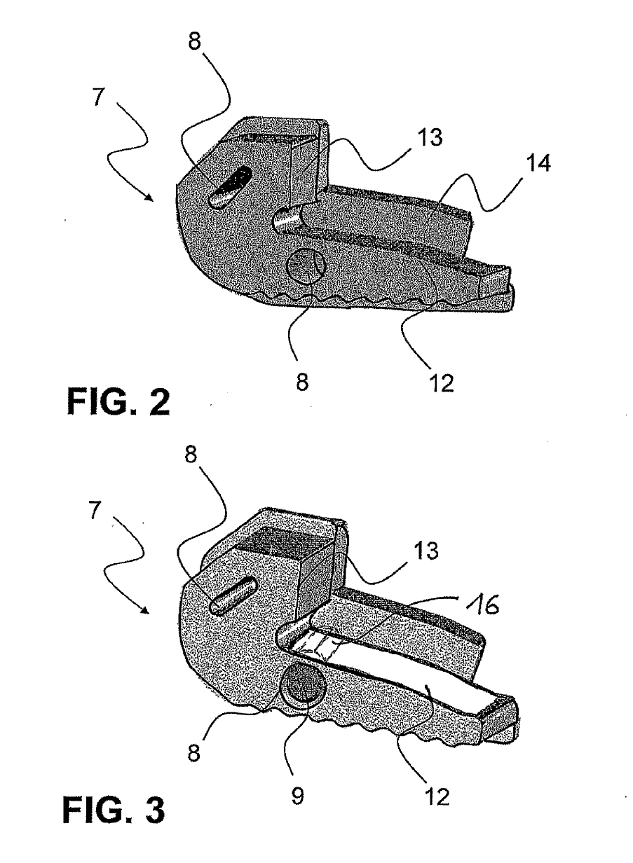

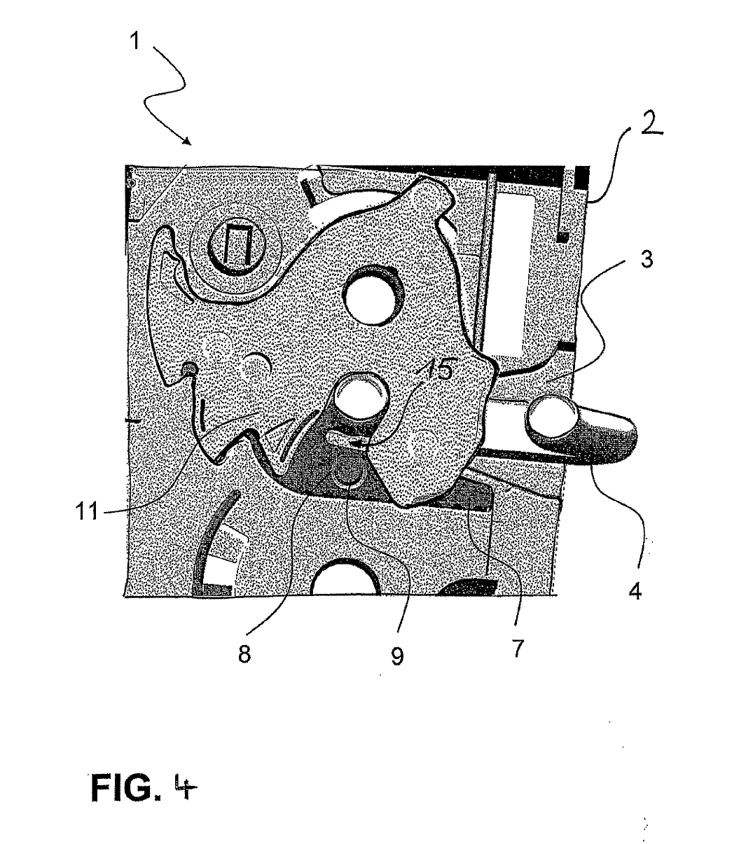

FIGS. 2 and 3 are perspective views of other embodiments of the damper element 7. The damper element 7 is L-shaped with a longer inlet leg 12 and a shorter impact leg 13. In the area of the shorter impact leg 13 an elongated opening 8 is provided without a rigid insert 9. Such rigid insert 9 is formed, however, in the opening 8 disposed in the longer inlet leg 12 (the two figures show this in detail before and after the assembly of both parts). To explain, it should be noted that the damper element 7 is shown as being formed in the back with a contour 14, which allows for the fixing of the damper element 7 in the motor vehicle lock, especially in the inlet 3. Also indicated is a bulge 16.

The rigid insert 9 (pin) is made of POM. In this application, the opening 8 for the rigid insert 9 in the damper element has a diameter of about 4 mm and a depth of about 12.2 mm (blind bore).

The rigid insert 9 has a diameter of between 4 mm and 5 mm. Different diameters allow different vehicles to have custom-adjusted fixation and damping functions of the latch pin in the main catch position. In the event that a kind of a spring lip is provided between the inlet leg and the latch pin (see reference number 15 in FIG. 4), the spring lip can be pre-tensioned to different extents. The length of the cylindrical rigid insert 9 is, for example, about 12 mm.

FIG. 4 shows a locked position of the motor vehicle lock 2, in which the catch 11 holds the latch pin 4 securely in the inlet 3. Below the portion of the U-shaped latch pin 4 that is clasped by the catch 11, the damper element 7 can be recognized, which includes the rigid insert 7 in the opening 8.

### REFERENCE LIST

1. Device
2. Motor vehicle lock
3. Inlet
4. Latch pin
5. Entrance region
6. End region
7. Damper element
8. Opening
9. Rigid insert
10. Latched position
11. Catch
12. Inlet leg
13. Impact leg
14. Form contour
15. Spring lip
16. Bulge

1. A device (1) for a motor vehicle lock (2) comprising an inlet (3) for a latch pin (4), wherein said inlet (3) has an entrance region (5) and an end region (6) with at least one damper element (7), said damper element (7) can absorb a contact force coming from said latch pin (4), said damper element (7) has at least one opening (8), and a rigid insert (9) is disposed in said opening (8) against said damper element (7).

2. The device of claim 1, wherein said opening (8) is a blind bore and said rigid insert (9) is a plastic pin.

3. The device of claim 1, wherein said damper element (7) and said rigid insert (9) form a bearing lining for the locking pin (4).

4. The device of claim 1, wherein said rigid insert (9) is formed laterally to a latched position (10) of said latch pin (4) in said inlet (3).

5. The device of claim 2, wherein said damper element (7) and said rigid insert (9) form a bearing lining for the locking pin (4).

6. The device of claim 2, wherein said rigid insert (9) is formed laterally to a latched position (10) of said latch pin (4) in said inlet (3).

7. The device of claim 3, wherein said rigid insert (9) is formed laterally to a latched position (10) of said latch pin (4) in said inlet (3).

8. The device of claim 5, wherein said rigid insert (9) is formed laterally to a latched position (10) of said latch pin (4) in said inlet (3).
